(19) United States
(12) Patent Application Publication
(10) Pub. No.: US 2006/0159914 A1
(43) Pub. Date: Jul. 20, 2006

(54) Branded adhesive tape

(75) Inventors: Jeffrey R. Beard, Aberdeen, WA (US); William M. Gibbons, Hoquiam, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Tapemorr, LLC

(21) Appl. No.: 11/035,929

(22) Filed: Jan. 14, 2005

(51) Int. Cl. B32B 7/12; B32B 27/04

(52) U.S. Cl. 428/354; 428/356; 442/149

(57) ABSTRACT

An apparatus and method for a branded adhesive tape are disclosed herein.

### TECHNICAL FIELD

Embodiments of the invention relate generally to the field of marketing, and more particularly to an adhesive tape having brand labels disposed thereon.

### BACKGROUND

Purveyors often spend a considerable amount of resources developing brand recognition in the consuming public. Successful brand development allows the consumer to differentiate between goods and/or services provided by various purveyors.

Successful development of a brand is only part of an effective marketing strategy. Brand visibility, especially amongst the target demographic, is also necessary to reinforce brand recognition and facilitate brand recall in the minds of potential customers.

Stickers are often used as a vehicle to present the brand to the public. Branded stickers are ornamental and typically serve no other function but to display the brand. Although the purveyor has a vested interest in the display of the brand, few others may share such a compelling interest. Therefore, the primarily ornamental functions of stickers limit the perpetuation of the brand by failing to provide sufficient incentive for consumers to acquire the stickers and subsequently display the brand label.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates an adhesive tape roll having a brand label in accordance with an embodiment of the present invention; and

FIGS. 2(a)-2(d) illustrate cross-sectional views of phases of production of the branded adhesive tape, in accordance with an embodiment of the present invention.

### DETAILED DESCRIPTION

Illustrative embodiments of the present invention include a branded adhesive tape.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific materials and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

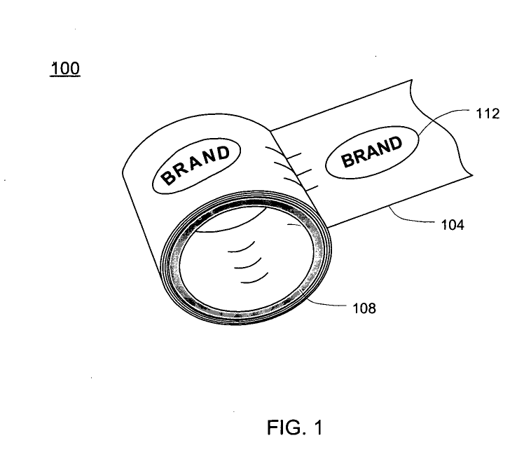

FIG. 1 illustrates a tape roll 100 in accordance with an embodiment of the present invention. In this embodiment, the tape roll 100 may include an adhesive tape 104 wrapped around a core such as, e.g., a cardboard tube 108. The adhesive tape 104 may include a brand label 112 printed thereon. In various embodiments, the adhesive tape 104 may be a fabric-based tape with structural and/or adhesive properties adapted for any number of a wide variety of applications.

In an embodiment the brand label 112 may be directly associated with a purveyor in the marketplace, e.g., a trademark of the purveyor. The purveyor may be in the business of providing goods and/or services, either directly or indirectly, to consumers. In an embodiment the brand label 112 may be associated with one or more of the goods and/or services. In one embodiment, the goods and/or services may not involve the manufacture of the tape roll 100 itself. In this embodiment the tape roll may act as a conduit for the advertising of the purveyor, not the manufacturer. It may be noted that while the purveyor may indeed be a manufacturer of a product, reference herein to a “manufacturer” may refer to the producer of the tape roll 100 unless otherwise stated.

In one embodiment, an advertising campaign on behalf of the purveyor may be initiated using tape rolls 100 to provide strategic brand placement. A campaign may involve acquiring control over the tape rolls 100 and subsequently distributing the tape rolls 100 through various channels. For example, in one embodiment the tape rolls 100 may be distributed through selected retail establishments that may be associated with the retail of adhesive tapes having properties similar to those of the adhesive tape 104.

In these retail establishments the tape roll 100 may be marketed for the functionality associated with the properties of the adhesive tape 104. For example, in one embodiment the adhesive tape 104 may be duct tape. Duct tape has vaulted to an almost infamous ubiquity in garages and homes of consumers. Duct tape has gained a large market share by exhibiting properties that prove useful in a wide variety of applications. Customers having positive experiences with duct tape in the past may continue to purchase the product in the future.

A purveyor may capitalize on the positive experiences and continued purchases of duct tape by associating their brand label 112 with such a product. In this embodiment, the purveyor may benefit from the goodwill associated with the adhesive tape 104, which may in turn facilitate introduction of the purveyor's brand label 112 into a target market segment.

Benefits may also inure to the manufacturer as the presence of the brand label 112 may help to differentiate the product from other products having similar properties. In one embodiment, a motivating factor behind the purchase of the tape roll 100 may be due to positive associations with the purveyor. This may provide the tape roll 100 a sales advantage over other tape rolls that may be in a competitive posture.

In one embodiment, retail establishments may be selected for distribution of the tape rolls 100 based at least in part upon an overlap of the purveyor's target market segment and the retailer's primary customers. For example, although duct tape's use is not restricted to any particular market segment, the home and auto repair markets may reflect higher concentration of sales of this particular tape than other markets. If the purveyor wished to advertise to members of these markets, the purveyor may find retail establishments catering to these markets an effective conduit for distribution of the tape rolls 100. Focusing marketing energies and resources through these conduits may result in a significant return on investment.

In another embodiment, tape rolls 100 may be distributed through promotional activities. For example, in one embodiment distribution of the branded tape rolls 100 may occur at an event likely to draw a number of members of a target market group. For example, in one embodiment the target market group may be car enthusiasts and an associated promotional campaign may involve the distribution of the branded tape rolls 100 at a car-racing event. Car-racing events have proven to be increasingly popular activities and have claim to be the largest spectator sport in the United States. These events present an opportunity to market directly to a substantial congregation of the car-enthusiast market segment. A purveyor may conduct a targeted promotional campaign by passing out branded tape rolls 100 to fans that gather by the thousands to watch these events. These branded tape rolls 100 will go home with the members of this market segment and serve as a periodic reminder of the purveyor's brand label 112. In one embodiment, these branded tape rolls may be distributed at a reduced- or no-cost basis.

Once the branded tape rolls are distributed to recipients they may provide a high level of brand visibility for the brand label 112. A recipient may use the branded tape roll 100 in the tasks normally allocated to such a product. In one embodiment, the branded tape roll 100 may have approximately 180 feet of adhesive tape 104. If one brand label 112 was placed in every 6 inches of tape 104, the tape roll 100 would have approximately 360 brand labels 112. Use of the entire tape roll 100 would place approximately 360 brand labels throughout a recipient's garage, home, etc. Through this and similar manners, embodiments of the present invention may provide unique opportunities for the purveyor to have its brand label perpetuated by a recipient in a repetitive, lasting manner.

In various embodiments, the brand labels repetitively placed on a tape may be a collection of different, but related brand labels. In other embodiments, the brand labels repetitively placed on a tape may not only be different, but unrelated aslo.

This repetitious use and reflective placement may facilitate brand recall in the recipient. Therefore, when the recipient has a need to purchase a product similar to products affiliated with the brand label 112, memory recall of the brand label 112 may facilitate sales of the purveyor's goods and/or services.

Although the above discussion focuses largely on duct tape, other embodiments may include other adhesive tapes, such as, but not limited to, masking tape, athletic tape, or gaffing tape. Each type of tape may appeal to members of diverse market segments due to the particular properties of the tape. Various branding opportunities may therefore appeal to a wide-range of purveyors.

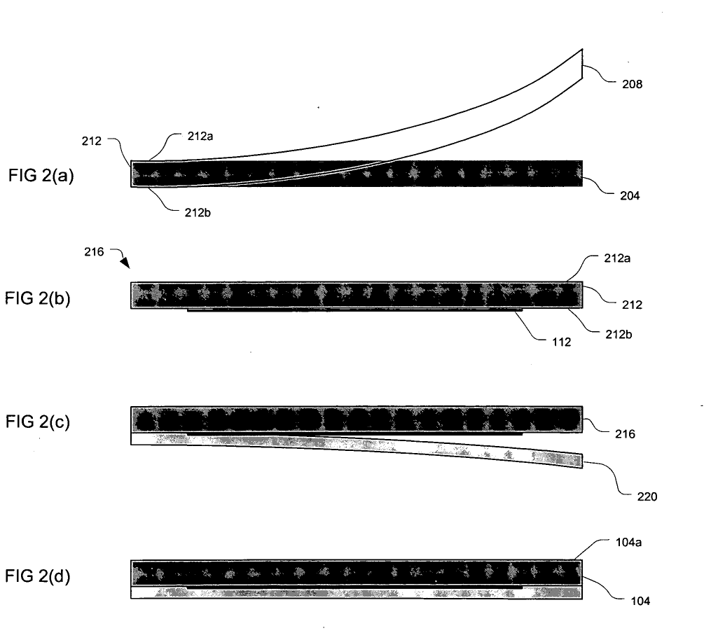

FIGS. 2(a)-2(d) illustrate cross-sectional views of phases involved in the manufacture of the adhesive tape 104 in accordance with an embodiment of the present invention. In particular, FIG. 2(a) illustrates a fabric-mesh layer 204 being coated with a laminate 208. The fabric-mesh layer 204 may provide many of the structural properties of the adhesive tape 104 including, but not limited to, the tensile strength. In one embodiment the fabric-mesh layer 204 may be a cotton batting. The thread count and tightness of the weave may contribute to the quality and/or grade of the adhesive tape 104.

In one embodiment, the laminate 208 may provide protection to the fabric-mesh layer 204 from, e.g., moisture and abrasion. The coating phase illustrated in FIG. 2(a) may involve melted laminate 208 being applied to the fabric-mesh layer 204 through a rolling operation or by some other manner. In one embodiment the laminate 208 may be a polyethylene coating. The combined fabric-mesh layer 204 and laminate 208 may be referred to as the laminated fabric 212. The laminated fabric 212 may have a first surface 212a and a second surface 212b.

In one embodiment, the laminated fabric 212 may be allowed to cool so that the laminate 208 regains structural cohesiveness. FIG. 2(b) illustrates the brand label 112 being printed on the surface 212b of the laminated fabric 212, in accordance with an embodiment of the present invention. In one embodiment, the brand label 112 may be printed in the negative and the laminated fabric 212 may be substantially translucent so that the brand label 112 may be viewed from the surface 212a.

In various embodiments the brand label 112 may be printed with black or colored ink. The viewed color of the brand label 112 may be impacted through tints provided through the laminated fabric 212. Color casting of the viewed brand label 112 may be adjusted through adjusting both the color of the ink used and the tint of the laminated fabric 212.

In one embodiment the brand label 112 may be printed onto the laminated fabric 212 by offset lithopressing. Other embodiments may employ other manners of printing. The laminated fabric 212 with the brand label 112 may be referred to as a branded laminated fabric 216.

FIG. 2(c) illustrates a cross-sectional view of an adhesive 220 being applied to the branded laminated fabric 216 in accordance with an embodiment of the present invention. In one embodiment, the adhesive 220 may be heated to a molten state prior to application. The adhesive 220 application may be done through a rolling operation or by some other manner. The thickness of the applied adhesive 220 may depend at least in part upon the desired adhesion properties of the tape 104.

In one embodiment, the adhesive 220 may be a rubber-based adhesive. In various embodiments the adhesive 220 may be a polymer-based adhesive or some other type.

FIG. 2(d) illustrates a cross-sectional view of the branded adhesive tape 104 in accordance with an embodiment of the present invention. The adhesive tape 104 may be spooled onto the core (cardboard tube) 108 with the adhesive 220 facing towards the center of the tube 108. Therefore, the surface 212a may face outward and come in contact with the adhesive 220 on the outer concentric layer. Having the brand label 112 placed on the surface 212b may allow the strength of the adhesive 220 to be decided on without compromises based on concerns of pulling up the ink of the brand label 112. This may facilitate providing the adhesive tape 104 with the properties that are desired for the utilitarian aspects of the tape 104.

In various embodiments the brand label 112 may be printed on any surface that is between the outer surface 104a and the adhesive 220. Various embodiments may include sublayers between the surface 104a and the adhesive 220 other than ones shown and discussed in the above embodiments. For example, in one embodiment the brand label 112 may be printed on a surface of the fabric-mesh layer 204, which may or may not have a laminate 208 coating, that is facing the surface 104a. An outer laminate layer may then be coated over the surface of the fabric-mesh layer 204.

In one embodiment, the phases illustrated in FIGS. 2a-2d, may be discrete phases. For example, each phase may be done independent from a preceding or following phase. The product of the phase may be spooled upon completion of the phase and stored until needed for the following phase.

In other embodiments, the phases may be integrated in varying degrees. In one embodiment, the phases may be done in an integrated manufacturing process, with the product flowing from one phase directly into the next.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A tape comprising:
a first layer having a first surface and a second surface;
an adhesive coupled to the second surface; and
a first brand label disposed between the first surface and the adhesive.

2. The tape of claim 1, wherein the first brand label is disposed on a portion of the second surface.

3. The tape of claim 2, wherein the first layer comprises a laminated fabric.

4. The tape of claim 3, wherein the laminated fabric comprises a fabric-mesh layer.

5. The tape of claim 4, wherein the fabric mesh layer comprises a cotton batting.

6. The tape of claim 4, wherein the laminated layer comprises a polyethylene coating applied to the fabric-mesh layer.

7. The tape of claim 2, wherein the first layer is substantially translucent.

8. The tape of claim 1, wherein the adhesive comprises a rubber-based adhesive.

9. The tape of claim 1, wherein the tape is duct tape or athletic tape.

10. The tape of claim 1, wherein the tape further comprises a second brand label disposed between the first surface and the adhesive.

11. The tape of claim 10, wherein the first and second brand labels are identical brand labels.

12. The tape of claim 10, wherein the first and second brand labels are different brand labels.

13. A method comprising:
providing a first layer having a first surface and a second surface;
applying an adhesive to the second surface; and
printing a brand label on a third surface that is between the first surface and the adhesive.

14. The method of claim 13, wherein the third surface is a portion of the second surface.

15. The method of claim 13, wherein printing a brand label further comprises:
printing a negative of the brand label.

16. The method of claim 13, wherein printing a brand label further comprises:
offset lithopressing the brand label onto the first surface.

17. A method comprising:
acquiring control over an adhesive tape having a brand label printed on a first surface, the brand label being associated with a purveyor who is not the manufacturer of the adhesive tape; and
distributing the adhesive tape.

18. The method of claim 17, wherein said distributing of the adhesive tape comprises:
selling the adhesive tape at one or more selected retail establishments.

19. The method of claim 17, wherein said distributing of the adhesive tape comprises:
distributing the adhesive tape as a part of a promotional campaign for said purveyor.

20. The method of claim 17, wherein said distributing of the adhesive tape comprises:
distributing the adhesive tape to one or more members of a target market associated with the brand label.

21. The method of claim 17, wherein the brand label is at least associated with the purveyor or one or more products of the purveyor.

22. The method of claim 21, wherein the brand label is associated with one or more products of the purveyor and the one or more products do not include the adhesive tape.

23. The method of claim 17, wherein the adhesive tape is selected from a group consisting of duct tape, gaffing tape, and athletic tape.
